(19) United States
(12) Patent Application Publication
(10) Pub. No.: US 2025/0247023 A1
(43) Pub. Date: Jul. 31, 2025

(54) Electromagnetic Kinetic Energy Harvester

(71) Applicant: Enervibe Ltd., Airport City (IL)

(72) Inventor: Michael Haronian, Tzur Hadasa (IL)

(73) Assignee: Enervibe Ltd., Airport City (IL)

(21) Appl. No.: 18/426,414

(22) Filed: Jan. 30, 2024

Related U.S. Application Data
(63) Continuation-in-part of application No. 17/591,609, filed on Feb. 3, 2022, now abandoned.

(51) Int. Cl. H02N 2/18; H02K 35/02

(52) U.S. Cl. CPC H02N 2/186; H02K 35/02

(57) ABSTRACT

Methods and electromagnetic energy harvester for converting movements of bodies to electricity or rotations and vibrations of wheels of vehicles while traveling to electricity that includes a coil fixed to the body or to the wheel, a rotary magnetic generator axially connected to the body or to the wheel distal from its center of gravity and a stationary magnet fixed to the body or to the wheel. The axial connection of the rotary magnetic generator and the relative fixation of the stationary magnet enable a magnetic force between the magnets to rotate the rotary magnetic generator about its axial connection to an equilibrium rotation angle, and that axial connection enables the vibrations, rotations or movements of the body or the wheel to rotate the rotary magnetic generator out from that equilibrium rotation angle, and these cyclical rotations create alternating voltage between ends of the coil.

### TECHNICAL FIELD

The present disclosure is related to an electromagnetic kinetic energy harvester that uses movements into rotations converter that includes a rotary magnetic generator and a stationary magnet.

### PRIOR ART

State of the art magnetic kinetic energy harvester, described schematically in FIG. 1, uses a main magnet (30) suspended over a spring (50) close to a coil (40) and harvest the electricity developing in the coil when the main magnet move relative to the coil as a result of the kinetic excitation and shockwaves of the body (60) to which the harvester is connected. The voltage developing between the coil ends (41) and (42) may be harvested using an appropriate electronic circuit. In these electromagnetic harvesters the spring (50) serves as a restoring force. A drawback of such configuration is the need for a stop (61) in order to prevent the magnet-spring system from moving beyond the elastic range of the spring. On the other hand, when the main magnet hits the stop (61) it may damage the main magnet and the body of the harvester which reduces the lifetime of the harvester.

### BRIEF DESCRIPTION OF THE FIGURES

FIG. 1 depicts the Prior art.

FIGS. 2-4 schematically depict the harvester of the present invention.

FIG. 5 schematically depicts the wheel and the car.

FIG. 6 schematically depicts the harvester with two stationary magnets.

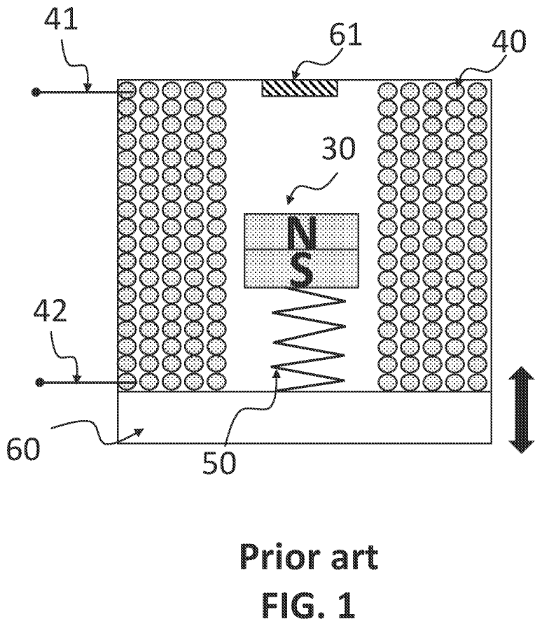

### THE INVENTION

The present invention relates to electromagnetic kinetic energy harvester that converts rotations, vibration or a linear motion of a body into rotation of an electromagnetic device relative to a coil where the electromagnetic device and the coil may be fixed to the body or to a frame or a casing that is fixed to the body. The electromagnetic device may be a simple magnet. The magnet may be a symmetrical or a non-symmetrical magnet fixed to the body by a hinge such that the center of gravity is off the center of the hinge such that rotations or movements of the body cause the magnet to rotate around the hinge (axis of rotations) and relative to the coil. The invention uses a stationary magnet that replaces the spring that is used in the prior art. The rotation of the magnet around a hinge instead of a straight movement that requires a stop, and the use of a stationary magnet results in a robust kinetic energy harvester.

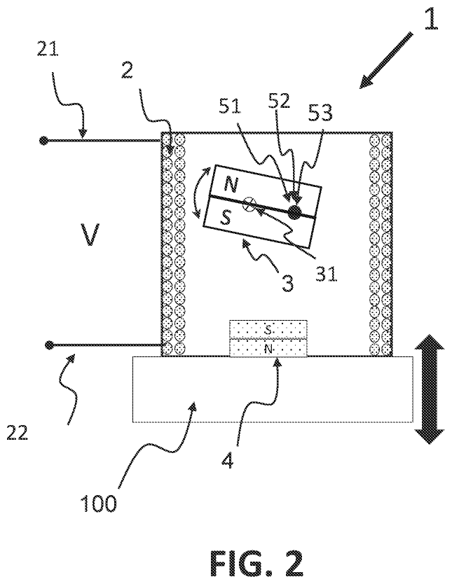

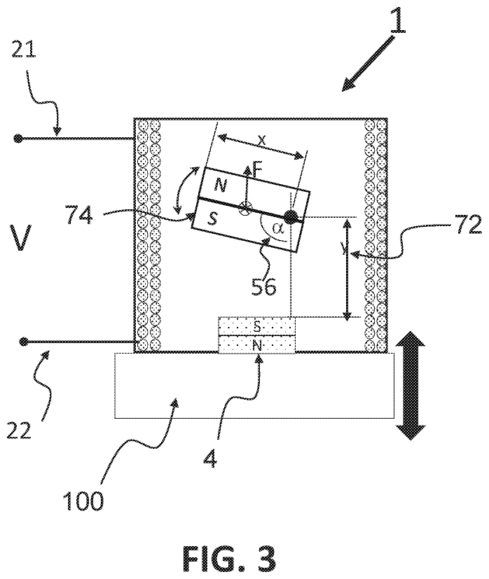

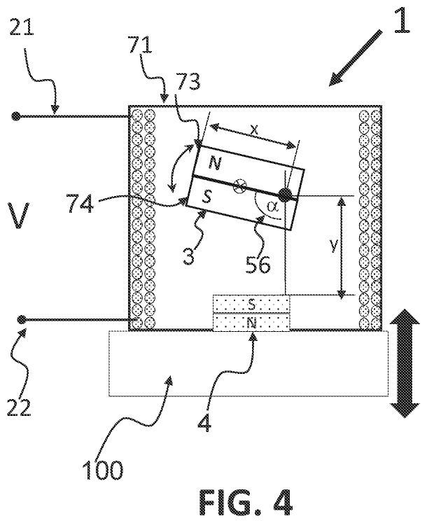

FIGS. 2-4 are a schematic depiction of the harvester (1). In more details, the present invention refers to an electromagnetic energy harvester (1) for converting kinetic excitations such as impacts, vibrations or movements in general, of a body (100) to electricity. The harvester (1) includes a coil (2) with two ends (21) (22), a rotary magnetic generator (3), and a stationary magnet (4) that is fixed to the body (100).

The rotary magnetic generator may be a magnet in a whole, or a unit that only part of which is made of magnetic material. The rotary magnetic generator may have a shape with preferred mechanical moment and preferred response to mechanical excitations. The rotary magnetic generator may have any preferred shape including an oval shape. The rotary magnetic generator may be comprised of several magnets arranged in a way to enhance the change in the magnetic flux at the coil when the rotary magnet rotates. For example, such an enhancement may be created by arranging several magnets to form a magnetic lens.

The axial connection of the rotary magnetic generator to the body may be done by a variety of connecting means (53), such as a pin, axis, hinge, bearing, and the like.

The rotary magnetic generator (3) may be connected to the body (100) by a hinge (similar to an axial connection) at a connecting point (51) that enables the rotary magnetic generator (3) to rotate about its axis of rotation (52). The connection of the rotary magnetic generator to the body is in the connecting point that makes the axis of rotation in a distal and away from the center of gravity (31) of the rotary magnetic generator (3).

The axial connection and the fixation of the stationary magnet in relation to the axis of rotation are designed to enable the magnetic force (F) between the magnets to rotate the rotary magnetic generator about the axial connection to an equilibrium rotation angle (56).

The axial connection is designed to enable the movements of the body to rotate the rotary magnetic generator out from the equilibrium rotation angle and these cyclical rotations of the rotary magnetic generator are designed to create the alternating voltage between the two ends of the coil. In other words, the movements (the kinetic excitations) of the body (100) cause the rotary magnetic generator (3) to rotate about its axis of rotation (52) in such a way that the center of gravity (31) of the rotary magnetic generator (3) rotates in relation to the stationary magnet (4) out from the equilibrium rotation angle, and when the excitation stops the stationary magnet (4) causes the rotary magnetic generator (3) to rotate backwards to the equilibrium rotation angle. These rotations of the rotary magnetic generator that happened relative to the coil (when its center of gravity rotates cyclically in relation to the stationary magnet (4)) create alternating voltage between the ends (21) (22) of the coil (2).

In summary, the present invention discloses the electromagnetic energy harvester (1) for converting movements of the body (100) to electricity. The harvester (1) includes:
(a) The coil (2), with the two ends (21) (22), that is fixed to the body, or to a frame (71) that is fixed to the body.
(b) The rotary magnetic generator (3) that is axially connected to the body, or to the frame, at the connecting point (51) that is distal from the center of gravity (31) of the rotary magnetic generator, such that the rotary magnetic generator is able to rotate about the axis of rotation (52) in relation to the body. And
(c) The stationary magnet (4) that is fixed to the body, or to the frame, such that the stationary magnet is fixed in relation to the axis of rotation.

The axial connection and the fixation of the stationary magnet in relation to the axis of rotation are designed to enable the magnetic force (F) between the magnets to rotate the rotary magnetic generator about the axial connection to the equilibrium rotation angle (56). The axial connection is designed to enable the movements of the body to rotate the rotary magnetic generator out from the equilibrium rotation angle, and these cyclical rotations of the rotary magnetic generator are designed to create alternating voltage between the two ends of the coil.

It is preferably that the distance (x) from the axis of rotation to a farthest point (73) on the edge (74) of the rotary magnetic generator will be smaller than the distance (y) from the axis of rotation to the stationary magnet (4) for avoiding collisions.

The present invention discloses also an electromagnetic energy harvester (1) for converting rotations of a wheel (76) of a vehicle (77) while travelling to electricity. The harvester includes:
(a) The coil (2) with the two ends (21) (22) that is fixed to a frame (71) that is fixed to a specific area (78) on a tire (75) that is mounted on the wheel.
(b) The rotary magnetic generator (3) that is axially connected to the frame, at the connecting point (51) that is distal from the center of gravity (31) of the rotary magnetic generator, such that the rotary magnetic generator is able to rotate about the axis of rotation (52) in relation to the frame. And
(c) The stationary magnet (4) that is fixed to the frame, such that the stationary magnet is fixed in relation to said axis of rotation.

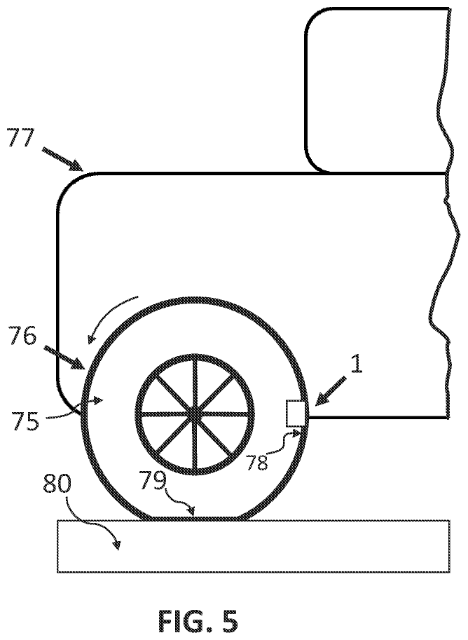

The axial connection is designed to enable the rotations of the wheel to rotate the rotary magnetic generator out from the equilibrium rotation angle when a force is applied on the magnet. During traveling, the harvester (1) crosses a contact patch (79) of the tire with ground (80) The contact patch is characterized in change from round tire to flat tire. This result in changes in the centrifugal forces applied on the rotary magnet as well as in a sudden change in the movement direction of the frame. Such change in centrifugal forces and sudden change in direction of the frame may cause cyclic rotations of the magnet relative to the coil that is fixed to the frame, which generates alternating voltage between the two ends of the coil. FIG. 5 schematically depicts the wheel and the car.

The axial connection and the fixation of the stationary magnet in relation to the axis of rotation are designed to enable the magnetic force (F) between the magnets to rotate the rotary magnetic generator about the axial connection to the equilibrium rotation angle (56) relative to a line perpendicular to a the specific area when crosses the contact patch (79) of the tire with the ground (80) during the traveling of the vehicle (when there is no centrifugal force on the harvester and on the magnets). The axial connection is designed to enable the rotations of the wheel to rotate the rotary magnetic generator out from the equilibrium rotation angle when the specific area rolls outside the contact patch, due to the centrifugal force that acts on the rotary magnetic generator.

These cyclical rotations of the rotary magnetic generator are designed to create alternating voltage between the two ends of the coil.

In some cases, the inertia of the rotary magnetic generator, as it enters and exits the contact patch, maintain its orientation while the frame with the coil, that are fixed to the tire, change the direction when entering and exiting the contact patch. This causes a change in the angle between the rotary magnetic generator and the line perpendicular to the specific area, and therefore leading to a rotation of the rotary magnetic generator relative to the coil which generates a voltage between the two ends of the coil.

In this invention it is stated that the movement of the body generates cyclic rotations of the rotary magnet relative to the equilibrium rotation angle and relative to the coil. It is understood that the rotary magnet may also complete a full rotation.

The present invention discloses also an electromagnetic energy harvester (1) for converting vibrations (and not only rotations) of the wheel (76) of the vehicle (77) while travelling to electricity that has the structure as stated above.

The present invention also discloses methods for converting rotations and vibrations of the wheel of the vehicle while traveling to electricity. The methods include first steps of providing the electromagnetic energy harvester that includes the frame that is designed to be fixed on the tire that is mounted or designed to be mounted on the wheel, a coil that is fixed to the frame, the rotary magnetic generator that is axially connected to the frame, and the a stationary magnet that is fixed to the frame.

In the case of rotations of the wheel: the axial connection and the fixation of the stationary magnet in relation to the axis of rotation are designed to enable the magnetic force between the magnets to rotate the rotary magnetic generator about the axial connection to the equilibrium rotation angle when the specific area with the harvester crosses the contact patch, and the axial connection enables these rotations of the wheel to rotate the rotary magnetic generator out from that equilibrium rotation angle when the specific area rolls outside the contact patch;

The second step in the case of rotations of the wheel: rotating the rotary magnetic generator about the axial connection to the equilibrium rotation angle by driving the vehicle when the specific area with the electromagnetic energy harvester crosses the contact patch of the tire with the ground.

The third step in the case of rotations of the wheel: rotating the rotary magnetic generator out from the equilibrium rotation angle by driving the vehicle when the specific area rolls outside the contact patch.

These cyclical rotations of the rotary magnetic generator create alternating voltage between the two ends of the coil.

In the case of vibrations of the wheel: The axial connection and the fixation of the stationary magnet in relation to the axis of rotation enable the magnetic force between the magnets to rotate the rotary magnetic generator about the axial connection in a direction of the equilibrium rotation angle, and the axial connection enables forces, derived from the vibrations of the wheel, to rotate the rotary magnetic generator outside the direction of the equilibrium rotation angle.

The second step in the case of vibrations of the wheel: rotating the rotary magnetic generator about the axial connection to the equilibrium rotation angle and rotating the rotary magnetic generator out from the equilibrium rotation angle, by driving the vehicle, and these cyclical rotations of the rotary magnetic generator create the alternating voltage between the two ends of the coil.

The present inventions relates also to a method for converting movements, rotations or vibrations of a body to electricity. The method includes the following steps and components.
(a) Provide the electromagnetic energy harvester that includes the frame, the coils with two ends that is fixed to frame, the rotary magnetic generator that is axially connected to the frame, at the connecting point that is distal from the center of gravity of the rotary magnetic generator, such that the rotary magnetic generator is able to rotate about the axis of rotation in relation to the frame, and the stationary magnet that is fixed to the frame, such that the stationary magnet is fixed in relation to the axis of rotation. The axial connection and the fixation of the stationary magnet in relation to the axis of rotation are designed to enable the magnetic force between the magnets to rotate the rotary magnetic generator about the axial connection in the direction of equilibrium rotation angle.
(b) Attach the electromagnetic energy harvester to the body. The axial connection of the rotary magnetic generator to the frame is designed to enable forces, derived from the movements, rotations or vibrations of the body, to rotate the rotary magnetic generator outside the direction of the equilibrium rotation angle, and these cyclical rotations of the rotary magnetic generator are designed to create the alternating voltage between the two ends of the coil.

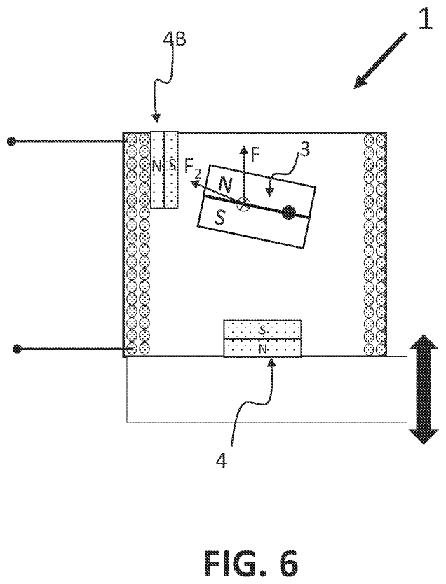

In some cases more than one stationary magnet may yield better results, and it is preferably to fix them in different directions in relation to the rotary magnetic generator in the manner of the magnetic forces between them. For example, FIG. 6 describes the harvester with additional stationary magnet (4B) that is positioned vertically to the stationary magnet (4). Such geometry showed higher voltage developing in the coil and faster conversion of mechanical energy to electrical energy compared to configuration with one stationary magnet. The use of several stationary magnets increases the voltage developed in the coil as well as improve the conversion of the mechanical power to electricity. These stationary magnets may be positioned around the rotary magnet in different locations and angles one relative to the other. The rotary magnetic generator in the harvester with a plurality of stationary magnets is more likely and easily to rotate by the mechanical power (vibrations, movements, rotations and the like) and by that such harvester harvest the electricity more efficiently. The harvester may therefore further includes the additional stationary magnet (4B) that is fixed to the body or the frame in a way that the direction of the magnetic force (F2) between the additional stationary magnet (4B) and the rotary magnetic generator (3) is different than the direction of the magnetic force (F) between the stationary magnet (4) to the rotary magnetic generator (3).

What is claimed is:

1. An electromagnetic energy harvester for converting movements of a body to electricity, comprising
(a) a coil with two ends that is fixed to the body, or to a frame that is fixed to the body,
(b) a rotary magnetic generator that is axially connected to the body, or to said frame, at a connecting point that is distal from a center of gravity of the rotary magnetic generator, such that the rotary magnetic generator is able to rotate about an axis of rotation in relation to the body, and
(c) a stationary magnet that is fixed to the body, or to said frame, such that the stationary magnet is fixed in relation to said axis of rotation,
wherein said axial connection and said fixation of the stationary magnet in relation to said axis of rotation are designed to enable a magnetic force between said magnets to rotate the rotary magnetic generator about said axial connection to an equilibrium rotation angle,
wherein said axial connection is designed to enable said movements to rotate the rotary magnetic generator out from said equilibrium rotation angle; and
wherein said cyclical rotations of the rotary magnetic generator are designed to create alternating voltage between the two ends of the coil.

2. The electromagnetic energy harvester of claim 1 wherein a distance from said axis of rotation to a farthest point on an edge of said rotary magnetic generator is smaller than a distance from said axis of rotation to said stationary magnet.

3. The electromagnetic energy harvester of claim 1 that further includes an additional stationary magnet that is fixed to said body or said frame in a way that a direction of a magnetic force between the additional stationary magnet and said rotary magnetic generator is different than a direction of said magnetic force between said stationary magnet to the rotary magnetic generator.

4. An electromagnetic energy harvester for converting rotations of a wheel of a vehicle while travelling to electricity, comprising:
(a) a coil with two ends that is fixed to a frame that is fixed to a specific area on a tire that is mounted on the wheel,
(b) a rotary magnetic generator that is axially connected to said frame, at a connecting point that is distal from a center of gravity of the rotary magnetic generator, such that the rotary magnetic generator is able to rotate about an axis of rotation in relation to the frame, and
(c) a stationary magnet that is fixed to the frame, such that the stationary magnet is fixed in relation to said axis of rotation;
wherein said axial connection and said fixation of the stationary magnet in relation to said axis of rotation are designed to enable a magnetic force between said magnets to rotate the rotary magnetic generator about said axial connection to an equilibrium rotation angle when the specific area with the harvester crosses a contact patch of the tire with ground during said traveling;
wherein said axial connection is designed to enable said rotations of the wheel to rotate the rotary magnetic generator out from said equilibrium rotation angle when the specific area rolls outside said contact patch; and
wherein said cyclical rotations of the rotary magnetic generator are designed to create alternating voltage between the two ends of the coil.

5. The electromagnetic energy harvester of claim 4 wherein a distance from said axis of rotation to a farthest point on an edge of said rotary magnetic generator is smaller than a distance from said axis of rotation to said stationary magnet.

6. The electromagnetic energy harvester of claim 4 that further includes an additional stationary magnet that is fixed to said body or said frame in a way that a direction of a magnetic force between the additional stationary magnet and said rotary magnetic generator is different than a direction of said magnetic force between said stationary magnet to the rotary magnetic generator.

7. An electromagnetic energy harvester for converting vibrations of a wheel of a vehicle while travelling to electricity, comprising:
(a) a coil with two ends that is fixed to a frame that is fixed to a specific area on a tire that is mounted on the wheel,
(b) a rotary magnetic generator that is axially connected to said frame, at a connecting point that is distal from a center of gravity of the rotary magnetic generator, such that the rotary magnetic generator is able to rotate about an axis of rotation in relation to the frame, and
(c) a stationary magnet that is fixed to the frame, such that the stationary magnet is fixed in relation to said axis of rotation;
wherein said axial connection and said fixation of the stationary magnet in relation to said axis of rotation are designed to enable a magnetic force between said magnets to rotate the rotary magnetic generator about said axial connection in a direction of equilibrium rotation angle;
wherein said axial connection is designed to enable forces, derived from said vibrations, to rotate the rotary magnetic generator outside the direction of said equilibrium rotation angle; and
wherein said cyclical rotations of the rotary magnetic generator are designed to create alternating voltage between the two ends of the coil.

8. The electromagnetic energy harvester of claim 7 wherein a distance from said axis of rotation to a farthest point on an edge of said rotary magnetic generator is smaller than a distance from said axis of rotation to said stationary magnet.

9. The electromagnetic energy harvester of claim 7 that further includes an additional stationary magnet that is fixed to said body or said frame in a way that a direction of a magnetic force between the additional stationary magnet and said rotary magnetic generator is different than a direction of said magnetic force between said stationary magnet to the rotary magnetic generator.

10. A method for convening rotations of a wheel of a vehicle while traveling to electricity, comprising:
(a) providing an electromagnetic energy harvester that includes:
(i) a frame that is designed to be fixed on a tire that is mounted or designed to be mounted on the wheel of the vehicle,
(ii) a coil with two ends that is fixed to the frame,
(iii) a rotary magnetic generator that is axially connected to the frame, at a connecting point that is distal from a center of gravity of the rotary magnetic generator, such that the rotary magnetic generator is able to rotate about an axis of rotation in relation to the frame, and
(iv) a stationary magnet that is fixed to the frame, such that the stationary magnet is fixed in relation to said axis of rotation;
wherein said axial connection and said fixation of the stationary magnet in relation to said axis of rotation are designed to enable a magnetic force between said magnets to rotate the rotary magnetic generator about said axial connection to an equilibrium rotation angle when a specific area with the electromagnetic energy harvester crosses a contact patch of the tire with ground during said traveling; and wherein said axial connection is designed to enable said rotations of the wheel to rotate the rotary magnetic generator out from said equilibrium rotation angle when the specific area rolls outside said contact patch:
(b) rotating the rotary magnetic generator about said axial connection to the equilibrium rotation angle by driving the vehicle when the specific area with the electromagnetic energy harvester crosses the contact patch of the tire with the ground;
(c) rotating the rotary magnetic generator out from the equilibrium rotation angle by driving the vehicle when the specific area rolls outside said contact patch; and
wherein said cyclical rotations of the rotary magnetic generator are designed to create alternating voltage between the two ends of the coil.

11. The method for converting rotations of a wheel of a vehicle while traveling to electricity of claim 10 wherein a distance from said axis of rotation to a farthest point on an edge of said rotary magnetic generator is smaller than a distance from said axis of rotation to said stationary magnet.

12. The method for convening rotations of a wheel of a vehicle while traveling to electricity of claim 10 wherein said harvester further includes an additional stationary magnet that is fixed to said body or said frame in a way that a direction of a magnetic force between the additional stationary magnet and said rotary magnetic generator is different than a direction of said magnetic force between said stationary magnet to the rotary magnetic generator.

13. A method for converting vibrations of a wheel of a vehicle while traveling to electricity, comprising:
(a) providing an electromagnetic energy harvester that includes:
(i) a frame that is designed to be fixed on a tire that is mounted or designed to be mounted on the wheel of the vehicle,
(ii) a coil with two ends that is fixed to the frame,
(iii) a rotary magnetic generator that is axially connected to the frame, at a connecting point that is distal from a center of gravity of the rotary magnetic generator, such that the rotary magnetic generator is able to rotate about an axis of rotation in relation to the frame, and
(iv) a stationary magnet that is fixed to the frame, such that the stationary magnet is fixed in relation to said axis of rotation;
wherein said axial connection and said fixation of the stationary magnet in relation to said axis of rotation are designed to enable a magnetic force between said magnets to rotate the rotary magnetic generator about said axial connection in a direction of equilibrium rotation angle; and wherein said axial connection is designed to enable forces, derived from said vibrations, to rotate the rotary magnetic generator outside the direction of said equilibrium rotation angle;
(b) rotating the rotary magnetic generator about said axial connection to the equilibrium rotation angle and rotating the rotary magnetic generator out from the equilibrium rotation angle, by driving the vehicle; and
wherein said cyclical rotations of the rotary magnetic generator are designed to create alternating voltage between the two ends of the coil.

14. The method for converting vibrations of a wheel of a vehicle while traveling to electricity of claim 13 wherein a distance from said axis of rotation to a farthest point on an edge of said rotary magnetic generator is smaller than a distance from said axis of rotation to said stationary magnet.

15. The method for converting vibrations of a wheel of a vehicle while traveling to electricity of claim 13 wherein said harvester further includes an additional stationary magnet that is fixed to said body or said frame in a way that a direction of a magnetic force between the additional stationary magnet and said rotary magnetic generator is different than a direction of said magnetic force between said stationary magnet to the rotary magnetic generator.

16. A method for converting movements, rotations or vibrations of a body to electricity, comprising
(a) providing an electromagnetic energy harvester that includes:
(i) a frame,
(ii) a coil with two ends that is fixed to frame,
(iii) a rotary magnetic generator that is axially connected to the frame, at a connecting point that is distal from a center of gravity of the rotary magnetic generator, such that the rotary magnetic generator is able to rotate about an axis of rotation in relation to the frame, and
(iv) a stationary magnet that is fixed to the frame, such that the stationary magnet is fixed in relation to said axis of rotation;
wherein said axial connection and said fixation of the stationary magnet in relation to said axis of rotation are designed to enable a magnetic force between said magnets to rotate the rotary magnetic generator about said axial connection in a direction of equilibrium rotation angle;
(b) attaching the electromagnetic energy harvester to the body,
wherein said axial connection of the rotary magnetic generator to the frame is designed to enable forces, derived from said movements, rotations or vibrations, to rotate the rotary magnetic generator outside the direction of said equilibrium rotation angle; and wherein said cyclical rotations of the rotary magnetic generator are designed to create alternating voltage between the two ends of the coil.

17. The method for converting movements, rotations or vibrations of a wheel of a vehicle while traveling to electricity of claim 16 wherein a distance from said axis of rotation to a farthest point on an edge of said rotary magnetic generator is smaller than a distance from said axis of rotation to said stationary magnet.

18. The method for converting movements, rotations or vibrations of a wheel of a vehicle while traveling to electricity of claim 16 wherein said harvester further includes an additional stationary magnet that is fixed to said body or said frame in a way that a direction of a magnetic force between the additional stationary magnet and said rotary magnetic generator is different than a direction of said magnetic force between said stationary magnet to the rotary magnetic generator.
